(19) United States
(12) Patent Application Publication
(10) Pub. No.: US 2025/0220414 A1
(43) Pub. Date: Jul. 3, 2025

(54) SIGNALING PROCEDURE TO INDICATE GENERATIONAL CAPABILITIES OF WI-FI DEVICES

(71) Applicant: Cisco Technology, Inc., San Jose, CA (US)

(72) Inventors: Brian Donald Hart, Sunnyvale, CA (US); Juan Carlos Zuniga, Quebec (CA); Scott Blue, Oulu (FI); Stephen M. Orr, Wallkill, NY (US)

(21) Appl. No.: 19/005,175

(22) Filed: Dec. 30, 2024

Related U.S. Application Data
(60) Provisional application No. 63/616,044, filed on Dec. 29, 2023.

(51) Int. Cl. H04W 8/22; H04W 24/02; H04W 48/20; H04W 84/12

(52) U.S. Cl. CPC H04W 8/22; H04W 24/02; H04W 48/20; H04W 84/12

(57) ABSTRACT

In one aspect, the techniques described herein relate to a computer-implemented method that includes receiving, from a device associated with a Wi-Fi network, a signal. The signal may be configured to convey generational capabilities of the device to operate in the Wi-Fi network. The generational capabilities may include information on compliance of the device with wireless communication protocols of the Wi-Fi network. The method may further include determining a status of the device for operating in the Wi-Fi network based on the generational capabilities of the device included the signal and configuring one or more parameters for communicating with the device in the Wi-Fi network according to the status of the device. The method may further include communicating with the device using the one or more parameters.

### CROSS-REFERENCE TO RELATED APPLICATIONS

This application claims priority to U.S. patent application No. 63/616,044, filed Dec. 29, 2023, entitled “SIGNALING PROCEDURE TO INDICATE GENERATIONAL CAPABILITIES OF WIFI DEVICES,” which is incorporated by reference herein in its entirety.

### TECHNICAL FIELD

The present technology pertains to wireless communication network, and, more specifically, to a signaling procedure for indicating generational capabilities of network devices within a wireless network.

### BACKGROUND

Wi-Fi technology has undergone continuous evolution and innovation since its inception, resulting in significant advancements with each new generation. Following Wi-Fi 5 (802.11ac) there has been Wi-Fi 6 (802.11ax), Wi-Fi 7 (802.11be), and soon there will be Wi-Fi 8 (802.11bn) and presumably Wi-Fi 9 at some future time. Each iteration brings notable improvements in speed, capacity, efficiency, and overall performance.

Wi-Fi 5 introduced substantial upgrades over its predecessor, Wi-Fi 4 (802.11n). Wi-Fi 5 introduced the use of wider channel bandwidths, downlink multi-user MIMO (Multiple-Input Multiple-Output), and interoperable beamforming technologies. These advancements significantly increased data transfer rates and improved network capacity, allowing multiple devices to simultaneously connect and communicate more efficiently. Wi-Fi 6 included enhanced orthogonal frequency-division multiple access (OFDMA), uplink multi-user MIMO and target wake time (TWT) mechanisms and offered improved overall spectral efficiency and power management and better performance in crowded areas. Wi-Fi 7 (802.11be) delivers speeds of up to 36 Gbps, utilizing multi-link operation, advanced resource unit techniques, and improved modulation schemes. Wi-Fi 7 also focuses on reducing latency and enhancing security features.

Wi-Fi 8 (802.11bn) aims to revolutionize wireless connectivity by pushing data rates to new heights. It is expected to introduce advancements like multi-AP coordination, and seamless roaming, paving the way for futuristic applications and seamless connectivity experiences.

As Wi-Fi technology continues to evolve, each new generation brings improvements that address the growing demands of modern networks, including increased device density, higher data rates, lower latency, and better overall network performance. These advancements play a crucial role in enabling emerging technologies, supporting the proliferation of smart devices, and transforming the manner in which devices connect and communicate in an increasingly interconnected world.

### BRIEF DESCRIPTION OF THE DRAWINGS

To easily identify the discussion of any particular element or act, the most significant digit or digits in a reference number refer to the figure number in which that element is first introduced.

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 shows a pictorial diagram of an example wireless communication network according to some aspects of the present disclosure.

FIG. 2A illustrates an example of a wireless communication network spanning a single floor of a building according to some aspects of the present disclosure.

FIG. 2B depicts an illustrative schematic diagram for connectivity of an AP multi-link device (MLD) with multiple affiliated APs to a non-AP MLD with multiple affiliated non-AP STAs according to some aspects of the present disclosure.

FIG. 3 illustrates an example diagram for transmitting generational capability signals between access points within a wireless communication network according to some aspects of the present disclosure.

FIG. 4 illustrates a method 400 for a signaling procedure that indicates Wi-Fi generational capabilities of client devices according to some aspects of the present disclosure.

FIG. 5 shows an example of a computing system for implementing certain aspects of the present technology according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable unless the term “configurable” is explicitly used to distinguish from “configured.” The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Aspects of the present disclosure can be implemented in any device, system or network that is capable of transmitting and receiving radio frequency (RF) or light (such as visible, infra-red or ultra-violet) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF or light signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), carrier-sense multiple access/carrier avoidance (CSMA/CA), carrier-sense multiple access/carrier detection (CSMA/CD), orthogonal frequency division multiplexing (OFDM), single-user (SU) multiple-input multiple-output (MIMO) and multi-user (MU) MIMO. The described implementations also can be implemented using other wireless communication protocols or RF or light signals suitable for use in one or more of a wireless personal area network (WPAN), a wireless local area network (WLAN), a wireless wide area network (WWAN), or an internet of things (IOT) network.

IEEE 802.11, commonly referred to as Wi-Fi, has been around for three decades and has become arguably one of the most popular wireless communication standards, with billions of devices supporting more than half of the worldwide wireless traffic. The increasing user demands in terms of throughput, capacity, latency, spectrum, and power efficiency calls for updates or amendments to the standard to keep up with them. As such, Wi-Fi generally has a new MAC-PHY amendment after every few years with its own characteristic features. In the earlier generations, the focus was primarily higher data rates, but with ever increasing density of devices, area efficiency and quality of service has become a major concern for Wi-Fi networks. Due to this issue, the last two amendments (802.11ax (W-Fi6) and 802.11be (Wi-Fi 7)) amendments focused more on efficiency, QoS and harnessing the new 6 GHz spectrum though higher data rates were also included. The next expected update to IEEE 802.11 is coined as Wi-Fi 8. Wi-Fi 8 will attempt to further minimize latency and enhance determinism and efficiency to meet the ever-growing demand for the Internet of Things (IoT), high resolution video streaming, low-latency wireless services, etc.

Multiple Access Point (AP) coordination in Wi-Fi 8 refers to the operation of multiple access points in a wireless network to avoid interference and ensure efficient communication between the client devices and the network. When multiple access points are deployed in a network—for instance in buildings and office complexes—they can operate on the same radio frequency, which can cause interference and degrade the network performance. To mitigate this issue, access points can be configured to coordinate their transmissions and avoid overlapping channels.

Wi-Fi 7 introduced the concept of multi-link operation (MLO), which gives the devices (Access Points (APs) and non-AP Stations (non-AP STAs and sometimes just “STAs”)) the capability to operate on multiple links (or even bands) at the same time. MLO is considered in Wi-Fi-7 to improve the throughput of the network and improve the latency issues by allowing devices to use multiple links.

A multi-link device (MLD) may have several “affiliated” devices, each affiliated device having a separate PHY interface, and the MLD having a single link to the Logical Link Control (LLC) layer. In IEEE 802.11be, a multi-link device (MLD) is defined as: “A device that is a logical entity and has more than one affiliated station (STA) and has a single medium access control (MAC) service access point (SAP) to logical link control (LLC), which includes one MAC data service” (see: LAN/MAN Standards Committee of the IEEE Computer Society, Amendment 8: Enhancements for extremely high throughput (EHT), IEEE P802.11 be™/D0.1, September 2020, section 3.2). Connection(s) with an MLD on the affiliated devices may occur independently or jointly. A preliminary definition and scope of a multi-link element is described in section 9.4.2.247b of aforementioned IEEE 802.11be draft. An idea behind this information element/container is to provide a way for multi-link devices (MLDs) to share the capabilities of different links with each other and facilitate the discovery and association processes and hence data communication.

In multi-link operation (MLO) both a non-AP MLD (sometimes call a STA MLD) and an AP MLD have multiple affiliated STAs and then can setup multiple links that can be simultaneously active or active one-at-a-time or some variant in between. These links use different channels and the links may or may not use the same bands.

MLO allows sending PHY protocol data units (PPDUs) on more than one link between a STA and an AP. The links may be carried on different channels, which may be in different frequency bands. Based on the frequency band and/or channel separation and filter performance, there may be restrictions on the way the PPDUs are sent on each of the links.

MLO may include a basic transmission mode, an asynchronous transmission mode, and a synchronous transmission mode, amongst other modes.

In a basic transmission mode, such as Enhanced Multi-link Single Radio (EMLSR) mode, there may be multiple links, but a device may transmit a PPDU on one link at a time. The link for transmission may be selected as follows. The device (such as an AP or a non-AP STA) may count down a random back off (RBO) on both links and select a link that wins the medium for transmission. Practically, the other link may be blocked by in-device interference or transmissions by external devices, but under EMLSR rules the other link cannot be used until transmissions of the transmit opportunity (TXOP) on the winning link complete. In basic transmission mode, aggregation gains from MLO may not be achieved.

In an asynchronous transmission mode, a device may count down the RBO on both links and perform PPDU transmission independently on each link. The asynchronous transmission mode may be used when the device can support simultaneous transmission and reception with bands that have sufficient frequency separation such as separation between the 2.4 GHz band and the 5 GHz band. The asynchronous transmission mode may provide both latency and aggregation gains.

In a synchronous PPDU transmission mode, the device may count down the RBO on both links. If a first link wins the medium, both links may transmit PPDUs at the same time. The transmission at the same time may minimize in-device interference and may provide both latency and aggregation gains.

Multi-AP coordination is another feature proposed to improve the performance of Wi-Fi 8 networks via the upcoming IEEE 802.11bn amendment. Multi-AP coordination is directed toward utilizing (distributed) coordination between different APs to reduce inter-Basic Service Set (BSS) interference for improved spectrum utilization in dense deployments. MLO, on the other hand, supports high data rates and low latency by leveraging flexible resource utilization offered by the use of multiple links for the same device.

Support for seamless/smooth roaming capability is a strong consideration for Wi-Fi8 to improve Wi-Fi roaming quality. To support smooth roaming/mobility in a campus wide Wi-Fi network, clients can create association with the campus-network/ESS of some subset thereof instead of with an individual AP (MLD). The ESS might contain one or more mobility domains and each mobility domain might contain one or more “sub-mobility domains” (characterized, e.g., as “seamless mobility domain”) each of which can map to a tightly coupled zone such as a single campus, building or floor.

The client creates its association with the ESS network represented by a (sub)Mobility Domain MLD (Multi-Link Device), instead of associating with a single AP (MLD) within the ESS. Such an architecture will enable a client to roam seamlessly between AP MLDs without requiring (re)association and reestablishment of contexts with each new AP MLD, since the client associates with the Mobility Domain MLD covering all the AP MLDs of the ESS. The client establishes connectivity with the SMD and can roam within it with overheads minimized, with data transfer time pauses minimized and with various features to minimize data loss during roaming. Such an architecture can significantly reduce roaming time to realize seamless roaming.

In Wi-Fi7/11be, a non-AP MLD associates with an AP MLD as per the art. In Wi-Fi8, a non-AP MLD is proposed to establish connectivity with an ESS/MD/SMD and has link setup with one or more AP MLDs within that SMD. In both cases (Wi-Fi7 and Wi-Fi8) it is desirable to define a mechanism to enable atomic switch link operation to switch a current link to a new link (either within an MLD or across two MLDs) atomically, where the entire operation either succeeds fully or is not executed. This ensures that the non-AP MLD would not end up in a situation where its current link got deleted, but the new link did not get added to its ML setup (e.g. because the AP or its link is already too crowded and a new STA can't be accepted for it).

The 802.11be amendment defines the Link Reconfiguration Request/Response frames for add link and delete link operation. Using this, a switch link operation can be achieved by including both delete link and add link within the same request frame. However, in the existing mechanism AP always accepts the delete link, not knowing the intent of the non-AP MLD.

### OVERVIEW

In a wireless communication network, different generations (e.g., older and/or newer versions) of access points (APs), non-AP STAs, or other network devices, may be utilized at the same time. In some examples, the different generations or versions of APs and non-AP STAs may have different capabilities. This may also apply to Wi-Fi generational capability. Aspects of the present disclosure are directed to incorporating and signaling certified “Generational Capabilities” of network devices (e.g., non AP STAs) among various devices operating in a wireless network to indicate performance capabilities of a particular device (e.g., what features may or may not be usable on a particular device) and the level of testing demonstrated such as interoperability testing. In the “Generational Capabilities” signaling, an optional sub-element or sub-field may be provided that includes a text string (e.g., can be one or more text strings that is trademarked by the Wi-Fi Alliance (WFA) such as, for example, “Wi-Fi CERTIFIED ™”, “Wi-Fi CERTIFIED Wi-Fi 6” “Wi-Fi CERTIFIED Wi-Fi 7”, etc.) This approach is a simplified mechanism for signaling the capabilities of Wi-Fi devices compared to, for example, cryptographic verification techniques, and is more privacy-preserving. Additionally, the present disclosure is directed to enabling associated APs on a wireless communication network to implement configurations based on the certified Generational Capabilities signaling received from other non-AP STAs, including, but not limited to, modifying transmissions, communications, signals, policies, behaviors, automated troubleshooting strategies, etc., based on the certified Generational Capabilities signaling.

In one aspect, the techniques described herein relate to a computer-implemented method that includes receiving, from a device associated with a Wi-Fi network, a signal. The signal may be configured to convey generational capabilities of the device to operate in the Wi-Fi network. The generational capabilities may include information on interoperability of the device with one or more generations of wireless communication protocols of the Wi-Fi network. The method may further include determining a status of the device for operating in the Wi-Fi network based on the generational capabilities of the device included in the signal and configuring one or more parameters for communicating with the device in the Wi-Fi network according to the status of the device. The method may further include communicating with the device using the one or more parameters.

In another aspect, the generational capabilities further include information on at least one of compliance, level of testing, and formal certification of the level of testing.

In another aspect, determining the status may also include determining that the device is interoperability tested and certified to operate within the Wi-Fi network, and, once certified, determining signaling capabilities of the device for operating in the Wi-Fi network.

In another aspect, determining the status may also include determining that the device is not certified to operate within or interoperate with the Wi-Fi network and transmitting a signal identifying the device as a device of concern to one or more other devices associated with the network.

In another aspect, the method may also include configuring the one or more parameters to include instructions to modify resources for communicating with the device.

In another aspect, wherein the status includes a trademarked text string that indicates a Wi-Fi generational certification.

In another aspect, the status includes a combination of one or more bitmaps and one or more text strings that indicate at least one of the conformance, testing, or testing certification level of the device for one or more Wi-Fi generations.

In another aspect, the one or more parameters include instructions to limit features based on the signal.

In one aspect, a system comprising one or more processors and a memory storing instructions that, when executed by the one or more processors, configure the system to receive, from a device associated with a Wi-Fi network, a signal. The signal may be configured to convey generational capabilities or the certified generational capabilities of the device to operate in or interoperate with the Wi-Fi network. The generational capabilities may include information on interoperability of the device with one or more generations of wireless communication protocols of the Wi-Fi network or interoperability with other certified devices. The system may further determine a status of the device for operating in the Wi-Fi network based on the generational capabilities of the device included in the signal and configure one or more parameters for communicating with the device in the Wi-Fi network according to the status of the device. The system may further communicate with the device using the one or more parameters.

In one aspect, a non-transitory computer-readable storage medium, the non-transitory computer-readable storage medium including instructions that when executed by a computer, cause the computer to receive, from a device associated with a Wi-Fi network, a signal. The signal may be configured to convey generational capabilities of the device to operate in the Wi-Fi network. The generational capabilities may include information on interoperability of the device with one or more generations of wireless communication protocols of the Wi-Fi network. The computer may further determine a status of the device for operating in the Wi-Fi network based on the generational capabilities of the device included in the signal and configure one or more parameters for communicating with the device in the Wi-Fi network according to the status of the device. The computer may further communicate with the device using the one or more parameters.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for a way to signal certified Wi-Fi Generational Capabilities of devices in a network. As Wi-Fi technology develops, there still exists equipment that has not been upgraded to include new features incorporated in new Wi-Fi rollouts and developments (e.g., Wi-Fi 7). However, older equipment is still necessary to functionality in a Wi-Fi network and in communications between user devices. There currently exists a proposition to incorporate a “Generational Capabilities” signaling between devices to indicate performance capabilities of a particular device (e.g., what features may or may not be usable on a particular device). This may indicate each or recent or a highest version of Wi-Fi that is supported. However, there exists a need to discourage false claiming (e.g., a device that claims that it supports Wi-Fi 7 when it only supports up to Wi-Fi 5, or a device that claims that it was certified for Wi-Fi 7 when it was not certified at all, or was only certified up to Wi-Fi 5) and how a receiving device may adapt transmissions to accommodate an older device with limited capabilities.

In the “Generational Capabilities” signaling, an optional sub-element or sub-field that includes one or more texts string can be included. In some non-limiting examples, the text string(s) may be a trademarked phrase (e.g., by Wi-Fi Alliance (WFA)) including, but not limited to, “Wi-Fi CERTIFIED ™”, “Wi-Fi CERTIFIED Wi-Fi 6”, “Wi-Fi CERTIFIED Wi-Fi 7” etc. Unlike asserting a Boolean or integer capability which cannot be trademarked, WFA can license the use of this mark or these marks (text string(s)) and has legal recourse against vendors that advertise it outside the allowed use of the mark, which then makes it desirable to signal. This may make it an easier path than cryptographic verification of certification, and more privacy-preserving. The element may contain a single string that is a prerequisite for claiming any support for Wi-Fi generations, or specifically claims certification of the highest (or only) generation claimed, or of each generation claimed, or of recent generations claimed. Devices that are not certified may use an alternate string that may have the same length as the certified string for ease of signaling or may send no strings. These strings can be sent at association or after association in a protected management frame for greater protection/privacy.

A user device (and/or an access point) may apply different configurations depending on the capabilities of an associated device. For example, certain features, speeds, messaging, transmissions, etc. may be modified to accommodate an older, uncertified and/or under-certified device. A device (e.g., a user device, an access point, a client device, etc.) may refuse to connect to a second device unless it has indicated certification of certain of its reported Generational Capabilities. In some examples, associated devices may verify the Generational Capabilities signaling through one or more tests, and if the tests demonstrate that the signaling is inconsistent with the capabilities of the device, then the device may be flagged as an over-claiming AP/non-AP STA/device.

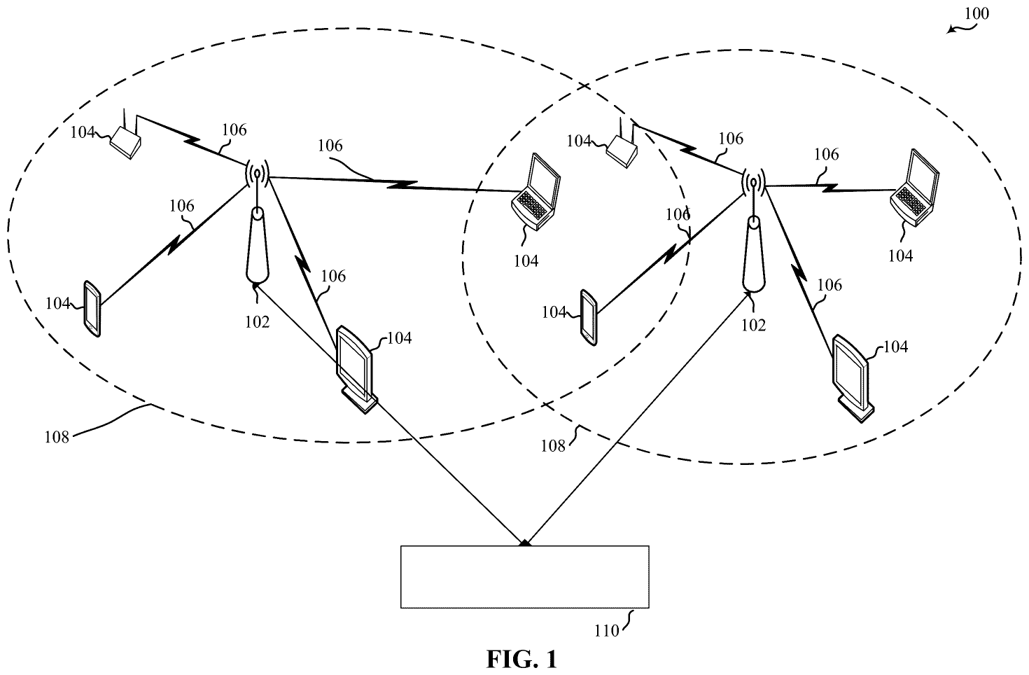

FIG. 1 illustrates a block diagram of an example wireless communication network 100. According to some aspects, the wireless communication network 100 may be an example of a wireless local area network (WLAN) such as a Wi-Fi network. For example, the wireless communication network 100 may be a network implementing at least one of the IEEE 802.11 family of wireless communication protocol standards and amendments thereof (such as that defined by the IEEE 802.11-2020 specification or amendments thereof including, but not limited to, 802.11ax, 802.11ay, 802.11az, 802.11ba, 802.11bb, 802.11bc, 802.11bd and 802.11be). Additionally, the wireless communication network 100 may implement future versions and amendments of the wireless communication protocol standards and amendments thereof such as 802.11bn and be modified according to the present disclosure to include the features contained herein. The wireless communication network 100 may include numerous wireless communication devices such as an AP actor, which can be one or more of a non-MLD AP, an AP affiliated with an AP MLD, and/or an AP MLD. In the examples presented herein, the AP actor can exclude an upper UMAC. Therefore, the AP actor can include the lower UMAC, LMAC, and/or PHY. Additionally, the WLAN can include one or more of non-AP STAs 104, which can be one or more of a non-MLD STA, a STA affiliated with a non-AP MLD, and/or a non-AP MLD. As illustrated, the wireless communication network 100 also may include multiple APs such as APs 102 (may also be referred to as simply AP). The APs 102 can be coupled to one another through a switch 110. While the APs 102 are shown as being coupled to one another through a switch 110, the network can provide another device that allows the coupling of the multiple APs.

Each of the non-AP STAs 104 also may be referred to as a mobile station (MS), a mobile device, a mobile handset, a wireless handset, an access terminal (AT), a user equipment (UE), a subscriber station (SS), client, or a subscriber unit, among other examples. The non-AP STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples. In other examples, the non-AP STAs 104 can be referred to as clients and/or client devices.

Any one of the APs 102 and an associated set of non-AP STAs 104 may be referred to as a basic service set (BSS), which is managed by a respective AP. Multiple APs and non-AP STAs, operating on different channels (and often on different channels in different bands) might be affiliated and function as AP MLDs and non-AP MLDs, respectively. FIG. 1 additionally shows an example coverage areas 108 of the each of the APs 102, which may represent a basic service area (BSA) of each of the BSSs; and the collective BSAs are serviced by the wireless communication network 100. As illustrated, three of the non-AP STAs 104 are within the BSA of each of the APs 102. The BSS may be identified to users by a service set identifier (SSID), where the BSS might be one of many in the SSID. The BSS may be identified to other devices by a unique (or substantially unique) basic service set identifier (BSSID). The BSS may be identified to other devices by a unique (or substantially unique) basic service set identifier (BSSID). One or more of the APs 102 periodically broadcasts beacon frames (“beacons”) including the BSSID to enable STAs 104 within wireless range of the APs 102 to “associate” with the AP or (for affiliated APs) “associate” with the AP MLD (i.e., the AP actor) to establish a respective communication link of communication links 106 (hereinafter also referred to as a “Wi-Fi link”), or to maintain the communication links 106, with the APs 102. The APs 102 may provide communication links 106 to the non-AP STAs 104 and therefore access to external networks. While the example has been described in regards to the APs 102 and non-AP STAs 104, the present disclosure extends such that an AP actor may provide access to external networks to various non-AP STAs in a WLAN via the communication links 106.

To establish the communication links 106 with any one of the APs 102, each of the non-AP STAs 104 is configured to perform passive or active scanning operations (“scans”) on frequency channels in one or more frequency bands (for example, the 2.4 GHz, 5 GHz, 6 GHz, or 60 GHz bands). To perform passive scanning, the non-AP STAs 104 listen for beacons, which are transmitted by a respective AP actor of APs 102 at or near a periodic time referred to as the target beacon transmission time (TBTT) (measured in time units (TUs) where one TU may be equal to 1024 microseconds (μs)). To perform active scanning, the non-AP STAs 104 generate and (in a simple implementation) sequentially transmit probe requests on each channel to be scanned and listen for probe responses from APs 102. The non-AP STAs 104 may be configured to identify or select an AP and thence a selected AP actor of APs 102 with which to associate based on the scanning information obtained through the passive and/or active scans, and to perform authentication and association operations to establish the communication links 106 with the selected AP actor of APs 102. The selected AP actor of APs 102 assigns an association identifier (AID) to the non-AP STAs 104 during the association operations, which the selected AP actor of APs 102 uses to improve the efficiency of certain signaling to the non-AP STAs 104.

The APs 102 and non-AP STAs 104 transmit and receive wireless communications (hereinafter also referred to as “Wi-Fi communications”) to and from one another in the form of PHY protocol data units (PPDUs). The APs 102 and non-AP STAs 104 also may be configured to communicate over other frequency bands such as shared licensed frequency bands, where multiple operators may have a license to operate in the same or overlapping frequency band or bands.

Each PPDU is a composite structure that includes a PHY preamble and a payload in the form of one or more PHY service data units (PSDUs). The information provided in the preamble may be used by a receiving device to decode the subsequent data in an intended PSDU. In instances in which PPDUs are transmitted over a bonded channel, selected preamble fields may be duplicated and transmitted in each of the multiple component channels.

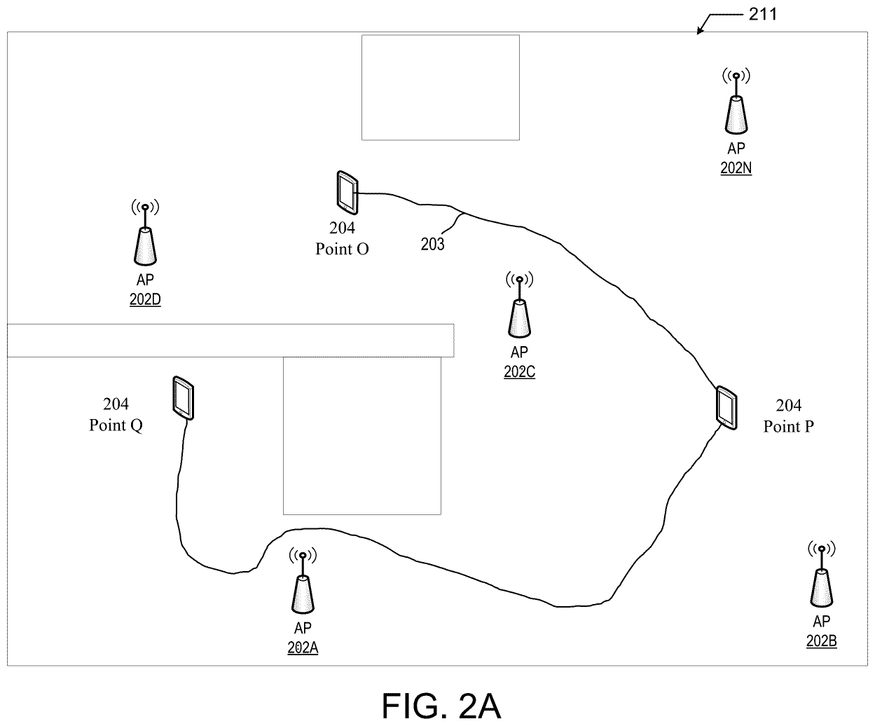

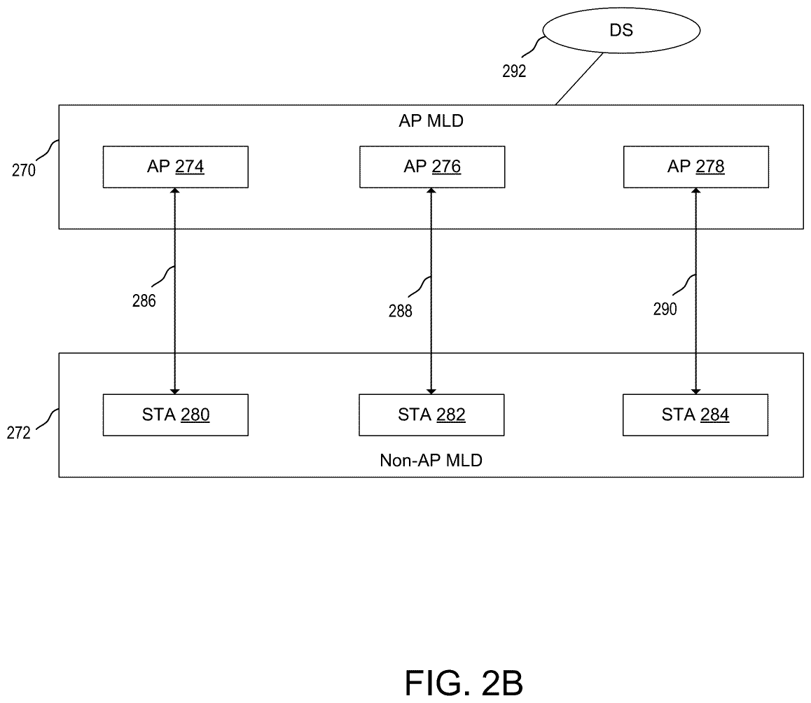

FIG. 2A illustrates an example a single floor 211 of building. While only a single floor is illustrated a description equally applies to multiple floors in a building. Additionally, some of the floors in a building may not be contiguous, such that floors 1, 3, 4, and 8 span a network for a building that has floors 1-10. Thus, in at least one implementation the building can include one or more floors that do not have a network including one or more APs. As illustrated, the single floor 211 includes APs 202A, 202B, 202C, 202D, 202N. Each of the APs 202A, 202B, 202C, 202D, 202N can have a respective coverage area such that an overall coverage area can span substantially the entire floor. In other examples, the overall coverage area can extend beyond the entire floor. Additionally, the coverage of an AP actor of APs 202A, 202B, 202C, 202D, 202N may substantially overlap with the coverage of another AP actor of the APs 202A, 202B, 202C, 202D, 202N.

As illustrated by the line 203, STA actor 204 can move from point O to point P to point Q. When a STA actor 204 is moving around on a given floor, one or more of the APs 202A, 202B, 202C, 202D, 202N can be considered to be nearest to the STA actor 204. Nearest, as used in relation to the APs 202A, 202B, 202C, 202D, 202N and STA actor 204, can include being physically nearest (for example, a Euclidean distance on the floor) and/or pathloss-nearest (for example, having the lowest wireless attenuation (pathloss) between AP actor, among all the APs, and STA actor). Additionally, the pathloss-nearest approach can be used to reduce the likelihood of connection between an AP actor on a floor above or below the STA actor 204. The location of the AP actor on the floor above or below might be closer in a Euclidean sense, but also not be a desirable AP for the connection of the device or station due to the floor location and/or possible signal interruption. The location of the AP actor on the floor above or below might be closer in a straight line and/or Euclidean sense, but also not be a desirable AP for the connection of the device or station due to the floor location and/or possible signal interruption. Additionally, the coverage of one or more APs can at least partially overlap with the coverage of one or more other APs.

FIG. 2B depicts an illustrative schematic diagram for MLO between an AP MLD with affiliated logical entities and a non-AP MLD with affiliated logical entities according to some aspects of the present disclosure.

Referring to FIG. 2B, two multi-link logical entities AP MLD 270 and Non-AP MLD 272 are shown. AP MLD 270 may include physical and/or logical affiliated AP 274, AP 276, and AP 278 operating in different channels and typically different frequency bands (e.g., 2.4 GHz, 5GHz, and 6 GHz). AP 274, AP 276, and AP 278 may be the same as or similar to any one of the APs described above. Non-AP MLD 272 may include non-AP STA 280, STA 282, and STA 284, which may be the same as or similar to any of the non-AP STAs as described herein.

AP 274 may communicate with non-AP STA 280 via link 286. AP 276 may communicate with non-AP STA 282 via link 288. AP 278 may communicate with non-AP STA 284 via link 290.

AP MLD 270 is shown in FIG. 2B to have access to a distribution system (DS) 292, which is a system used to interconnect a set of BSSs to create an extended service set (ESS).

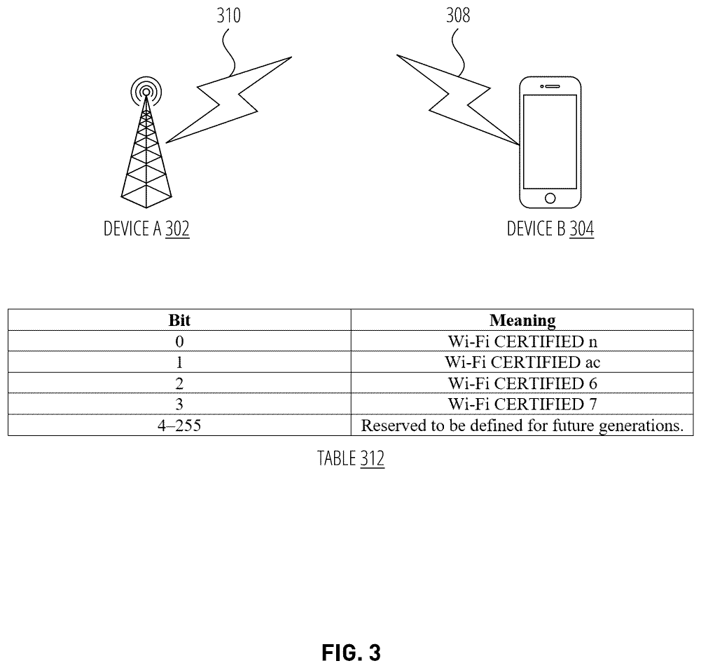

It should be understood that although the example shows three logical entities within the AP MLD and the three logical entities within the non-AP MLD, this is merely for illustration purposes and that other numbers of logical entities within each of the AP MLD and non-AP MLD may be envisioned. In some examples, an MLD may not be used in an embodiment. For example, one (non-AP) STA may be connected an AP without use of an MLD. The example Wi-Fi systems and MLO described above with reference to FIGS. 1 and 2A-B provide examples of simplified and example systems of the present disclosure. Additional details of the present disclosure are provided in relation to FIGS. 3, 4, and 5.

FIG. 3 illustrates an example diagram for transmitting generational capability signals between access points within a wireless communication network according to some aspects of the present disclosure. The wireless communication network may include access point (AP) A 302 and Device B 304. Device A 302 may be associated with signal 310 and Device B 304 may be associated with signal 308. The wireless communication network may also include other devices, including, but not limited to, additional APs, radios, SSIDs, virtual APs, STAs, any combination thereof, or the like. In FIG. 3, Device A may be shown as an AP (e.g., an AP affiliated with an AP MLD, an AP, etc.) and Device B may be shown as a user device (e.g., a mobile device, an STA of a non-AP MLD, a non-AP STA, a client device, etc.), but Device A and Device B may be any device associated with the wireless communication network. Including, but not limited to, APs, STA of a non-AP MLD, APs affiliated with an AP MLD, a non-AP STA, client device, user device, any combination thereof, or the like. In some examples, signal 310 and signal 308 may include Generational Capabilities signaling. For example, Generational Capabilities signaling may be an optional element, sub-element, field, and/or sub-field included in a transmission between one or more APs on the wireless communication network. The Generational Capabilities signaling may indicate the ability for a client device (e.g., a non-AP STA) to be capable of various Wi-Fi generations (e.g., Wi-Fi 4/5/6/6E/7) and for which of these, if any, the client has a certification.

The Generational Capabilities signaling may be comprised of one or more text strings, a bitmap, a numeric field, any combination thereof, or the like. For example, the Generational Capabilities signaling (e.g., signal 308 and signal 310) may include a string and a bitmap, such as a numeric field plus a trademarked text string, such as “Wi-Fi CERTIFIED.” In some other examples, the Generational Capabilities may include a bitmap with specific bits (n, n+1, n+2, etc.) assigned to indicate different Wi-Fi generations (e.g., bit “n” assigned as “1” indicates compatibility with Wi-Fi 4). In some examples, this may also include strings associated with the specific bits (e.g., bit “n” assigned to “1” is associated with a string “CERTIFIED Wi-Fi 4 ™”), In some examples, the strings may supersede the bits (e.g., just a single string with a single length, such as 62, “CERTIFIED Wi-Fi 4 ™ CERTIFIED Wi-Fi 5 ™ CERTIFIED Wi-Fi 6 ™”). The bitmap and/or the text strings may be in a single field (as shown previously) or may be in multiple fields (e.g. a list of strings, each with a length, such as 20, “CERTIFIED Wi-Fi 4 ™”, 20, “CERTIFIED Wi-Fi 5 ™”, 20, “CERTIFIED Wi-Fi 6 ™”) within the Generational Capabilities signaling. The Generational Capabilities signaling may include an indication that a client device is associated with more than one capability. For example, a signal may include an indication that a client device is capable of operating with Wi-Fi 5 and Wi-Fi 7, but not Wi-Fi 6. In some examples, an indication that a client device is capable of operating under a certain generation (e.g., Wi-Fi 6) may indicate that the client device is also capable of operating under older generations (e.g., Wi-Fi 4 and 5, but not Wi-Fi 7). As an illustrative example, signal 308 and/or signal 310 may be formatted as indicated in table 312, with specific bits being associated with respective meanings and/or intents.

In some examples, the text string included within the Generational Capabilities signaling may be registered with the United States Patent and Trademark Office and/or similar entities in other countries. The registered text string may be used to enforce an allowed use of the registered text string by providing a method of legal recourse against a vendor and/or entity that uses the registered text string outside of an approved license. In some examples, an alternative string (e.g., “WI-FI UNCERTIFIED”) may be transmitted in lieu of the certified text string to indicate that a client device may not be compatible or formally tested, such as interoperability tested, in regards to some Wi-Fi generations. In some examples, the text string may be modified to accommodate regulations and verbiage associated with different countries (e.g., including “Marque Deposee” for French language territories or an abbreviation thereof, and/or including “Marca Registrada” for Spanish language territories or an abbreviation thereof, etc.).

In some examples, signal 308 and/or signal 310 may be transmitted at association of one or more client devices (e.g., Device A 302 and/or Device B 304). In some other examples, signal 308 and/or signal 310 may be transmitted after association in a protected (encrypted) frame of the one or more client devices. This may increase protection and/or privacy of the one or more client devices.

After receiving the Generational Capabilities signaling from other client devices, an AP device may verify the signaling and ensure that the capabilities and/or certifications indicated by the other client devices is accurate. Device A 302 may receive signal 308 from Device B304 and may initiate a verification procedure to ensure the veracity of signal 308. For example, Device A 302 may transmit a verification message, signal, communication, command, any combination thereof, or the like, to Device B 304. The verification message may include instructions that are unique to a specific Wi-Fi generation and/or might focus on features that are prone to protocol error or interop error in that generation. For example, if signal 308 indicates that Device B 304 is compatible with Wi-Fi 7, then Device A 302 may transmit a verification message that may include a command that is only executable by a device that is compatible with and/or well tested for Wi-Fi 7. If signal 308 of Device B 304 is verified, then Device A 302 may communicate accordingly with Device B 304 (e.g., through standard communications, signaling, transmissions, etc.). In some examples, signal 308 may not be verified. Device B 304 may be identified as a concern (e.g., overclaiming certifications) and/or under-tested non-AP STA and flagged by the wireless communication network for de-bugging, analysis, troubleshooting, updating, deactivation, confinement to fewer wireless resources (e.g., 2.4 GHz only), any combination thereof, or the like. In some examples, Device A 302, upon the identification of Device B 304 as a concerning AP, may cease communications with Device B 304.

In some examples, the Generational Capabilities signaling may differ for one or more client devices associated with the same wireless communication network. For example, signal 310 may indicate a compatibility with Wi-Fi 5, while signal 308 may indicate a compatibility with Wi-Fi 7. However, devices with differing capabilities may still need to communicate across the wireless communication network. Thus, the a first STA (AP or non-AP) device may modify transmissions, resources, communications, and/or signals so that the first STA may be received by a specific peer (second) STA (non-AP or AP—potentially in any combination not respectively) and/or a group of peer second STAs (such as client devices) that may not operate with the same capabilities (e.g., a first client device may “downgrade” a transmission to be accessible by a second device (AP or client) with older generational capabilities). In some examples, an STA may implement configurations for communicating with various peer devices on the wireless communication network based on an associated compatibility. For example, Device A 302 may implement a configuration for communications with Device B 304 based on signal 308 (e.g., a compatibility or formal testing for with Wi-Fi 5). In some examples, the configuration may include an instruction to avoid, reduce, and/or eliminate transmissions with a client device. This might involve complete disconnection (sending a deauthentication frame+continued refusal to allow subsequent association), or something lesser, like denying access to certain bands, channels, or radios, especially if those bands, channels, or radios carry important traffic. In some examples, the configuration may include an instruction to modify the format of a transmission, communication, and/or signal that is intended for a client device.

In some examples, the generation capability of the one or more client devices may be transmitted to a central controller for processing. The central controller may maintain a database that may include references to the one or more client devices and an associated generational capability. The central controller may generate a report, based on the database, that includes an analysis of the generational capability of the one or more client devices. An administrator of the wireless communication network may analyze the report and may determine an upgrade schedule for various hardware components (e.g., the one or more AP and/or client devices).

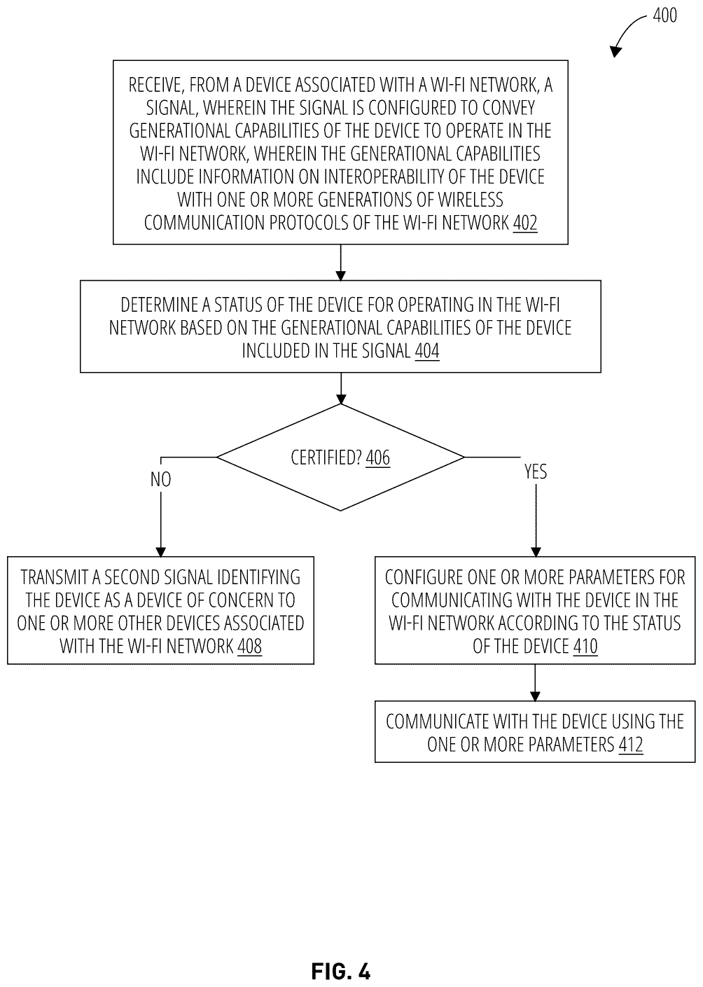

FIG. 4 illustrates a method 400 for a signaling procedure that indicates Wi-Fi generational capabilities of client devices according to some aspects of the present disclosure.

In block 402 of method 400, a first access point (AP) receives, from a device associated with a Wi-Fi network, a signal, wherein the signal is configured to convey generational capabilities of the device to operate in the Wi-Fi network, wherein the generational capabilities signaling includes information on interoperability of the device with one or more generations of wireless communication protocols of the Wi-Fi network. For example, Device A 302 (as described in FIG. 3) may receive, from Device B 304 (as described in FIG. 3) associated with the Wi-Fi network, signal 308 (as described in FIG. 3), wherein signal 308 is configured to convey generational capabilities of Device B 304 to operate in the Wi-Fi network, wherein the generational capabilities include information on compliance of the device with wireless communication protocols of the Wi-Fi network. The signal may be included in a Generational Capabilities signal and may be comprised of a text string, a bitmap, a numeric field, one or more of these, any combination thereof, or the like. The signal may include an indication that the device is capable of operating with one or more Wi-Fi generations (e.g., Wi-Fi 5, Wi-Fi 6, Wi-Fi 7, etc.). In some examples, the text string included within the Generational Capabilities signaling may be registered with the United States Patent and Trademark Office and/or other equivalent entities of different countries. The registered text string may be used to constrain the allowed uses of the registered text string by providing a method of legal recourse against a vendor and/or entity that uses the registered text string outside of an approved license.

In block 404 of method 400, the first AP may determine a status of the device for operating in the Wi-Fi network based on the generational capabilities of the device included in the signal. For example, Device A 302 may determine a status of Device B 304 for operating in the Wi-Fi network based on the generational capabilities of Device B 304 included in the signal. The first AP may transmit a verification message, signal, communication, command, any combination thereof, or the like to the device. The verification message may include instructions that are unique to a specific Wi-Fi generation. The instructions might be chosen to be ones that untested or under-tested implementations perform erratically or incorrectly.

In block 408 of method 400, based on a determination that the device is non-certified according to block 406 of method 400, the first AP may transmit a second signal identifying the device as a device of concern to one or more other devices associated with the Wi-Fi network. For example, Device A 302 may transmit a signal identifying Device B 304 as a device of concern to one or more other devices associated with the Wi-Fi network. In some examples, this may include flagging the device for de-bugging, analysis, troubleshooting, updating, deactivation, any combination thereof, or the like. In some other examples, this may include an instruction to avoid, reduce, and/or eliminate transmissions with the device.

In block 410 of method 400, based on a determination that the device is compliant according to block 406 of method 400, the first AP may configure one or more parameters for communicating with the device in the Wi-Fi network according to the status of the device. For example, Device A 302 may configure one or more parameters for communicating with Device B 304 in the Wi-Fi network according to the status of Device B 304. Devices with differing capabilities may still need to communicate across the wireless communication network. Thus, the one or more STAs such as AP devices may modify transmissions, communications, and/or signals so that they may be received by a specific client device and/or a group of client devices that may not operate with the same capabilities (e.g., a client device may “downgrade” a transmission to be accessible by a second client device with older Generational Capabilities). In some examples, the one or more client devices may implement configurations for communicating with various client devices on the wireless communication network based on an associated compatibility and level of testing. In some examples, the configuration may include an instruction to avoid, reduce, and/or eliminate transmissions with a client device. In some examples, the configuration may include an instruction to modify the format of a transmission, communication, and/or signal that is intended for a client device.

In block 412 of method 400, the first AP may communicate with the device using the one or more parameters. For example, Device A 302 may communication with peer STA (e.g., non-AP STA) B 304 using the one or more parameters. Subsequent communications between the first AP and the device may be modified, formatted, filtered, any combination thereof, or the like, according to the one or more parameters.

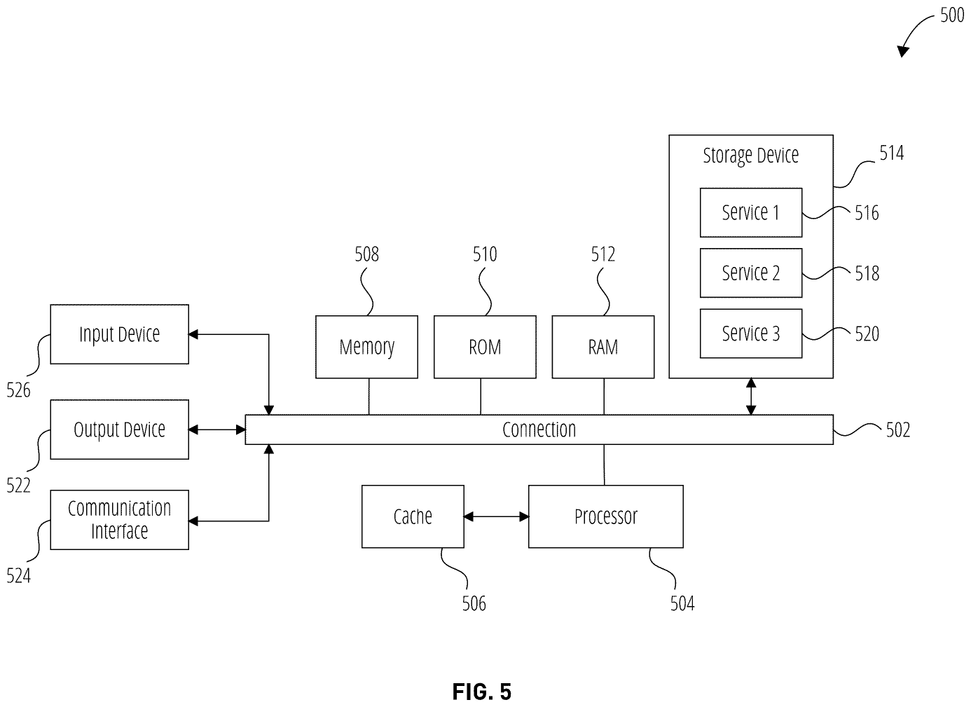

FIG. 5 shows an example of computing system 500, which can be for example any computing device making up the wireless communication network described in FIGS. 1-3, or any component thereof in which the components of the system are in communication with each other using connection 502. Connection 502 can be a physical connection via a bus, or a direct connection into processor 504, such as in a chipset architecture. Connection 502 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 500 includes at least one processing unit (CPU or processor) 504 and connection 502 that couples various system components including system memory 508, such as read-only memory (ROM) 510 and random access memory (RAM) 512 to processor 504. Computing system 500 can include a cache of high-speed memory 506 connected directly with, in close proximity to, or integrated as part of processor 504.

Processor 504 can include any general purpose processor and a hardware service or software service, such as services 516, 518, and 520 stored in storage device 514, configured to control processor 504 as well as a special-purpose processor where software instructions are incorporated into the actual processor design. Processor 504 may essentially be a completely self-contained computing system, containing multiple cores or processors, a bus, memory controller, cache, etc. A multi-core processor may be symmetric or asymmetric.

To enable user interaction, computing system 500 includes an input device 526, which can represent any number of input mechanisms, such as a microphone for speech, a touch-sensitive screen for gesture or graphical input, keyboard, mouse, motion input, speech, etc. Computing system 500 can also include output device 522, which can be one or more of a number of output mechanisms known to those of skill in the art. In some instances, multimodal systems can enable a user to provide multiple types of input/output to communicate with computing system 500. Computing system 500 can include communication interface 524, which can generally govern and manage the user input and system output. There is no restriction on operating on any particular hardware arrangement, and therefore the basic features here may easily be substituted for improved hardware or firmware arrangements as they are developed.

Storage device 514 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 514 can include software services, servers, services, etc., that when the code that defines such software is executed by the processor 504, it causes the system to perform a function. In some embodiments, a hardware service that performs a particular function can include the software component stored in a computer-readable medium in connection with the necessary hardware components, such as processor 504, connection 502, output device 522, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method, comprising:
receiving, from a device associated with a Wi-Fi network, a signal, wherein the signal is configured to convey generational capabilities of the device to operate in the Wi-Fi network, wherein the generational capabilities include information on interoperability of the device with one or more generations of wireless communication protocols of the Wi-Fi network;
determining a status of the device for operating in the Wi-Fi network based on the generational capabilities of the device included in the signal;
configuring one or more parameters for communicating with the device in the Wi-Fi network according to the status of the device; and
communicating with the device using the one or more parameters.

2. The computer-implemented method of claim 1, wherein the generational capabilities further include information on at least one of compliance, level of testing, and formal certification of the level of testing.

3. The computer-implemented method of claim 1, wherein determining the status comprises:
determining that the device is interoperability tested and certified to operate within the Wi-Fi network, and once certified, determining signaling capabilities of the device for operating in the Wi-Fi network.

4. The computer-implemented method of claim 1, wherein determining the status comprises:
determining that the device is not certified to operate within or interoperate with the Wi-Fi network, and
transmitting a second signal identifying the device as a device of concern to one or more other devices associated with the Wi-Fi network.

5. The computer-implemented method of claim 4, further comprising:
configuring the one or more parameters to include instructions to modify resources for communicating with the device.

6. The computer-implemented method of claim 1, wherein the status includes a trademarked text string that indicates a Wi-Fi generational certification.

7. The computer-implemented method of claim 1, wherein the status includes a combination of one or more bitmaps and one or more text strings that indicate conformance, testing or testing certification level of the device for one or more Wi-Fi generations.

8. The computer-implemented method of claim 1, wherein the one or more parameters include instructions to limit features based on the signal.

9. A system comprising:
one or more processors; and
a memory storing instructions that, when executed by the one or more processors, configure the system to:
receive, from a device associated with a Wi-Fi network, a signal, wherein the signal is configured to convey generational capabilities of the device to operate in the Wi-Fi network, wherein the generational capabilities include information on interoperability of the device with one or more generations of wireless communication protocols of the Wi-Fi network;
determine a status of the device for operating in the Wi-Fi network based on the generational capabilities of the device included in the signal;
configure one or more parameters for communicating with the device in the Wi-Fi network according to the status of the device; and
communicate with the device using the one or more parameters.

10. The system of claim 9, wherein the generational capabilities further include information on at least one of compliance, level of testing, and formal certification of the level of testing.

11. The system of claim 9, wherein determine the status comprises:
determine that the device is interoperability tested and certified to operate within the Wi-Fi network, and
once certified, determine signaling capabilities of the device for operating in the Wi-Fi network.

12. The system of claim 9, wherein determine the status comprises:
determine that the device is not certified to operate within or interoperate with the Wi-Fi network, and
transmit a second signal identifying the device as a device of concern to one or more other devices associated with the Wi-Fi network.

13. The system of claim 12, wherein the instructions further configure the system to:
configure the one or more parameters to include instructions to modify resources for communicating with the device.

14. The system of claim 9, wherein the status includes a trademarked text string that indicates a Wi-Fi generational certification.

15. The system of claim 9, wherein the status includes a combination of one or more bitmaps and one or more text strings that indicate conformance, testing, or testing certification level of the device for one or more Wi-Fi generations.

16. The system of claim 9, wherein the one or more parameters includes instructions to limit features based on the signal.

17. A non-transitory computer-readable storage medium, the non-transitory computer-readable storage medium including instructions that when executed by a computer, cause the computer to:
receive, from a device associated with a Wi-Fi network, a signal, wherein the signal is configured to convey generational capabilities of the device to operate in the Wi-Fi network, wherein the generational capabilities include information on interoperability of the device with one or more generations of wireless communication protocols of the Wi-Fi network;
determine a status of the device for operating in the Wi-Fi network based on the generational capabilities of the device included in the signal;
configure one or more parameters for communicating with the device in the Wi-Fi network according to the status of the device; and
communicate with the device using the one or more parameters.

18. The non-transitory computer-readable storage medium of claim 17, wherein the generational capabilities further include information on at least one of compliance, level of testing, and formal certification of the level of testing.

19. The non-transitory computer-readable storage medium of claim 17, wherein determine the status comprises:
determine that the device is interoperability tested and certified to operate within the Wi-Fi network, and
once certified, determine signaling capabilities of the device for operating in the Wi-Fi network.

20. The non-transitory computer-readable storage medium of claim 17, wherein determine the status comprises:
determine that the device is not certified to operate within or interoperate with the Wi-Fi network, and
transmit a second signal identifying the device as a device of concern to one or more other devices associated with the Wi-Fi network.
